(19) United States
(12) Patent Application Publication
(10) Pub. No.: US 2011/0161829 A1
(43) Pub. Date: Jun. 30, 2011

(54) Method and Apparatus for Dictionary Selection

(75) Inventor: Preben Kjaer Kristensen, Vallensback Strand (DK)

(73) Assignee: NOKIA CORPORATION, Espoo (FI)

(21) Appl. No.: 12/646,968

(22) Filed: Dec. 24, 2009

(51) Int. Cl. G06F 3/00

(52) U.S. Cl. 715/739

(57) ABSTRACT

An apparatus and method for receiving a first user input indicative of a geographical locus; selecting a first dictionary from a plurality of available dictionaries, based upon said geographical locus; and enabling use of the first dictionary during a second user input. Exemplary uses of the dictionary include predictive text, spellchecking, autocompletion, and translation in respect of the second user input.

### TECHNICAL FIELD

The present application relates generally to dictionary-assisted user input.

### BACKGROUND

Modern technologies, for example the internet, have made an ever-increasing amount of information available to the user of a given information device. A user can today obtain large quantities of information from distant data sources at a speed and cost that would not have been possible even a year ago. Together with more affordable international travel, this has given users of such devices an increased awareness and interest in foreign cultures and information, and has created an expectation in users that information from or about other countries should be readily available to them with minimal effort required to access it regardless of their location.

A significant barrier to communication across international boundaries is the need to make information in one language accessible to users who would normally use another.

It is now not uncommon for a single user to use more than one language when operating an information device. A multilingual user may write messages to different contacts in different languages, and access remote information in more than one language. There have been significant endeavours to make multilingual communication and data access available regardless of the user's mother tongue or ability to speak other languages.

It is now possible to manufacture information devices that have very small form factors. As a result, many user interfaces need to be provided within a very small area on the device, increasing the likelihood of typographical errors.

Typographical errors are particularly problematic when a user is inputting information using unfamiliar language, as he is then less likely to recognise such errors.

### SUMMARY

In a first aspect, the present invention provides an apparatus comprising: a processor; and memory including computer program code, the memory and the computer program code configured to, working with the processor, cause the apparatus to perform at least the following: receive a first user input indicative of a geographical locus; select a first dictionary from a plurality of available dictionaries, based upon said geographical locus; and enable use of the first dictionary during a second user input.

According to a second aspect of the present invention, there is provided: a method comprising: receiving a first user input indicative of a geographical locus; selecting a first dictionary from a plurality of available dictionaries, based upon said geographical locus; and enabling use of the first dictionary during a second user input.

According to a third aspect of the present invention, there is provided a computer program product comprising a computer-readable medium bearing computer program code embodied therein for use with a computer, the computer program code comprising: receiving a first user input indicative of a geographical locus; selecting a first dictionary from a plurality of available dictionaries, based upon said geographical locus; and enabling use of the first dictionary during a second user input.

According to a fourth aspect of the present invention, there is provided a computer-readable medium encoded with instructions that, when executed by a computer, perform: receiving a first user input indicative of a geographical locus; selecting a first dictionary from a plurality of available dictionaries, based upon said geographical locus; and enabling use of the first dictionary during a second user input.

Also disclosed is an apparatus comprising: means for receiving a first user input indicative of a geographical locus; means for selecting a first dictionary from a plurality of available dictionaries, based upon said geographical locus; and means for enabling use of the first dictionary during a second user input.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus according to an exemplary embodiment of the invention;

FIG. 2 is an illustration of an apparatus according to another exemplary embodiment of the invention;

FIG. 3 is a flow diagram illustrating operations for performing a method according to an embodiment of the invention;

FIGS. 4a-f are a series of illustrations showing a user interface dialogue;

FIGS. 5a-f are a series of illustrations showing a user interface window and dialogue; and

FIGS. 6a-d are a series of illustrations showing a user interface dialogue.

### DETAILED DESCRIPTION OF THE DRAWINGS

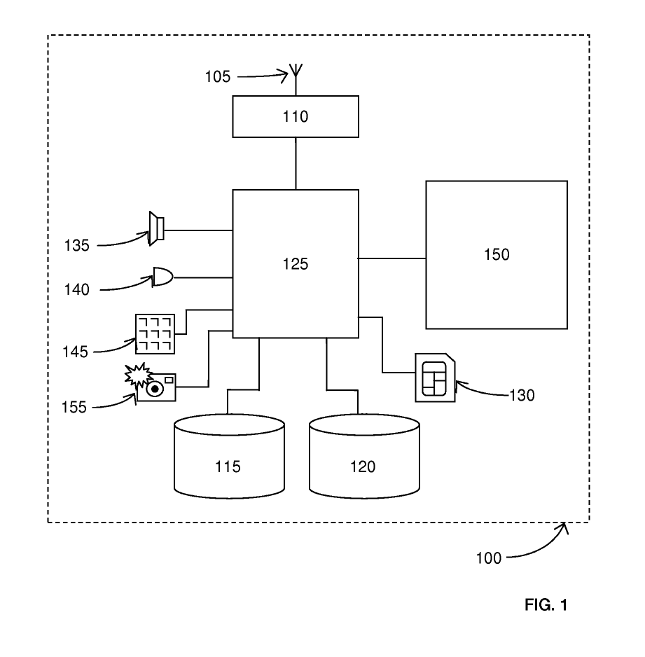

An example embodiment of the present invention and its potential advantages are understood by referring to FIGS. 1 through 6 of the drawings.

FIG. 1 illustrates a mobile communication device (MCD) 100 according to an exemplary embodiment of the invention. The MCD 100 may comprise at least one antenna 105 that may be communicatively coupled to a transmitter and/or receiver component 110. The MCD 100 also comprises a volatile memory 115, such as volatile Random Access Memory (RAM) that may include a cache area for the temporary storage of data. The MCD 100 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The MCD may comprise a processor 125 that can use the stored information and data to implement one or more functions of the MCD 100, such as the functions described hereinafter.

The MCD 100 may comprise one or more User Identity Modules (UIMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The MCD 100 may comprise a number of user interface components. For example, a microphone 135 and an audio output device such as a speaker 140. The MCD 100 may comprise one or more hardware controls, for example a plurality of keys laid out in a keypad 145. Such a keypad 145 may comprise numeric (for example, 0-9) keys, symbol keys (for example, #, *), alphabetic keys, and/or the like for operating the MCD 100. For example, the keypad 145 may comprise a conventional QWERTY (or local equivalent) keypad arrangement. The keypad 145 may also comprise one or more soft keys with associated functions that may change depending on the operation of the device. In addition, or alternatively, the MCD 100 may comprise an interface device such as a joystick or other user input interface.

The MCD 100 may comprise one or more display devices such as a screen 150. The screen 150 may be a touch screen, in which case it may be configured to receive input from a single point of contact, multiple points of contact, and/or the like. In such an embodiment, the touch screen may determine input based on position, motion, speed, contact area, and/or the like. Suitable touch screens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touch screen including touch events that involve actual physical contact and touch events that do not involve physical contact but that are otherwise detected by the touch screen, such as a result of the proximity of the selection object to the touch screen. The touch screen may be controlled by the processor 125 to implement an on-screen keyboard.

The MCD 100 may comprise a media capturing element such as a video and/or stills camera.

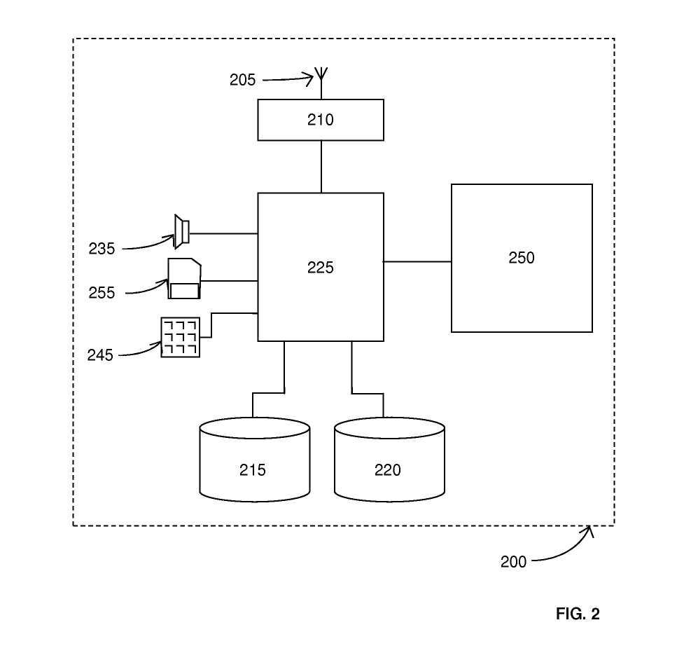

FIG. 2 illustrates a Mobile Navigation Device (MND) 200 according to another exemplary embodiment of the invention. The MND 200 may comprise at least one antenna 205 that may be communicatively coupled to a receiver 210. The antenna 205 and receiver 210 may be configured to receive data from a satellite navigation network, for example the Global Positioning System (GPS) array of satellites.

The MND 200 may also comprise a volatile memory 215, such as volatile Random Access Memory (RAM) including a cache area for the temporary storage of data. The MND 200 may also comprise other memory, for example, non-volatile memory 220, which may be embedded and/or be removable. The non-volatile memory 220 may comprise an EEPROM, flash memory, or the like. The memories may store any of a number of pieces of information, and data—for example an operating system for controlling the MND 200, application programs that can be run on the operating system, and user and/or system data. The data stored in the memories may include mapping and/or other navigational data, at least part of which may be stored in a removable memory module 255, the module being for example a flash memory module such as an SD Card. The information and data may be used by a processor 225 of the MND 200 to implement one or more functions of the MND 200, such as the functions described hereinafter.

The MND 200 may comprise a number of user interface components. For example, an audio output device such as a speaker 140, which may be controlled by the processor 225 to relay navigational information to a user. The MCD 100 may comprise one or more hardware controls, for example a plurality of keys laid out in a keypad 245. Such a keypad 145 may comprise numeric (for example, 0-9) keys, symbol keys (for example, #, *), alphabetic keys, and/or the like for operating the MND 200. For example, the keypad 245 may comprise a conventional QWERTY (or local equivalent) keypad arrangement. The keypad 245 may also comprise one or more soft keys with associated functions that may change depending on the operation of the device. In addition, or alternatively, the MND 200 may comprise an interface device such as a joystick or other user input interface.

The MND 200 may comprise one or more display devices such as a screen 250. The screen 250 may be a touch screen, in which case it may be configured to receive input from a single point of contact, multiple points of contact, and/or the like. In such an embodiment, the touch screen may determine input based on position, motion, speed, contact area, and/or the like. Suitable touch screens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touch screen including touch events that involve actual physical contact and touch events that do not involve physical contact but that are otherwise detected by the touch screen, such as a result of the proximity of the selection object to the touch screen. The touch screen may be controlled by the processor 225 to implement an onscreen keyboard.

It should be understood, however, that the MCD 100 and MND 200 as illustrated in FIGS. 1 and 2 and described herein are merely illustrative of electronic devices that could benefit from embodiments of the invention and, therefore, should not be taken to limit the scope of the invention. Whilst only the MCD 100 and MND 200 are illustrated, other types of electronic devices, such as mobile telephones, other mobile communication devices, portable digital assistants (PDAs), pagers, mobile computers, desktop computers, televisions, gaming devices, laptop computers, cameras, video recorders, satellite navigation devices, and other types of electronic systems, may readily employ embodiments of the invention.

Furthermore, devices may readily employ embodiments of the invention regardless of their intent to provide mobility. In this regard, even though embodiments of the invention are described in conjunction with mobile applications, it should be understood that embodiments of the invention may be used in conjunction with a variety of other applications, both in the mobile devices industries and outside of the mobile devices industries.

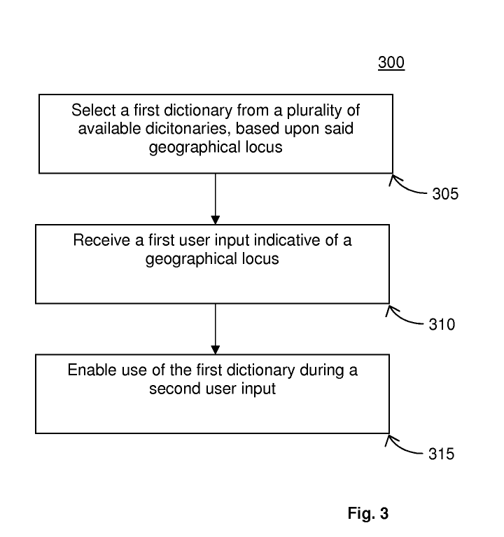

FIG. 3 illustrates a method 300 according to an exemplary embodiment of the present invention.

The method begins at step 305, where a first user input is received. The first user input is indicative of a geographical locus, which may be either a single geographical point or area, or the union of multiple points and/or areas. There are many ways in which the first user input could potentially indicate the geographical area; for example, the first user input may comprise one or more sets of geographical coordinates that the user inputs either in text or by selecting one or more points or areas on a map. Alternatively, the locus may be indicated by a user reference to a political area or landmark—it may be, for example, represent a country (e.g. France), or a city (e.g. Paris), an administrative district or postcode, or a particular building (e.g. the Eiffel Tower). The indication may not directly specify a particular geographical location, but instead may specify criteria that indicate a geographical locus (e.g. the user-entered heuristic “The largest city in France” indicates Paris, or “Areas of Belgium that are not francophone” indicates just the Dutch and German speaking areas of Belgium). It is enough that an indication of a geographical locus is derivable from the first user input.

Once a geographical area has been determined from the first user input, the method selects 310 a first dictionary from a plurality of available dictionaries based upon the geographical locus. This selection may be based upon predefined associations between geographical loci and dictionaries (for example a mapping of countries to their official languages), or it may be determined dynamically (e.g. by applying a function to determine the most relevant dictionary, for example by searching online to determine the official language(s) associated with the geographical locus).

In some cases, there may be no dictionary available that is appropriate for use with the geographical locus (i.e. matches the criteria for selecting a dictionary from a geographical locus), or more than one dictionary that is be appropriate. In such cases, the device may default to a predetermined behaviour, for example selecting a default dictionary (e.g. retaining a dictionary that is already currently active on the device), offering the user a manual selection of one or more dictionaries (e.g. a selection from all the available dictionaries, or from all the appropriate dictionaries), or choosing between multiple appropriate dictionaries according to their priority (e.g. as defined by user preferences) and selecting the highest-priority appropriate dictionary. In the absence of any appropriate dictionaries, the device may default to use no dictionaries during the second input by using multi-tap input or a similar input technology.

The selected dictionary may already be present locally on the device. Alternatively, the dictionary may be stored remotely, but downloadable or otherwise accessible by the device, and thereby still available to it.

After the first dictionary has been selected 310, its use is enabled 315 during a second input. This enablement can take one or more of many different forms. For example, the dictionary may be used to perform dictionary-based functions during the inputting of text.

In some embodiments, the second input is made using ambiguous text entry and the first dictionary may be used to resolve the ambiguity. For example, so-called ‘predictive text’ techniques may be used to map ambiguous key presses (e.g. when more than one character is assigned to a single key) against words from a dictionary in order to identify candidate words that match the ambiguous key presses. The selected dictionary can be used as the dictionary against which the predictive-text mappings are made. Similar techniques can be used to map other types of ambiguous input (e.g. voice recognition, handwriting recognition, etc.) against the selected dictionary.

The selected dictionary may be used to automatically complete partially entered words or phrases—a process known as “autocompletion”. In autocompletion, a substring of characters (e.g. a partial word) is mapped against words from a dictionary in order to identify candidate words that contains that substring. Often, but not necessarily, the autocompletion algorithm searches only for words that contain the substring as a prefix. The selected dictionary may be used as the dictionary against which the autocompletion mappings are made.

The selected dictionary may be used to check the spelling of words entered during the second user input. For example, the selected dictionary can be searched for each word that is entered during the second user input, and those words that are not present in the directory may then be highlighted. Correction candidates (e.g. the closest word matches in the dictionary) for the highlighted words can be presented to the user. Alternatively, words not found in the dictionary can be automatically replaced with the best correction candidate with or without alerting the user to the correction.

The selected dictionary may be a translation dictionary that can be used to translate words entered during the second input into a different language. For example, when the default language of the device is English and the selected dictionary is a French-English translation dictionary, text entered by the user as part of the second input may be translated, using the dictionary, from English into French.

Other uses of the selected dictionary are also possible during the second user input. Furthermore, the use may comprise two or more uses applied simultaneously or sequentially during the second user input (e.g. spellchecking, followed by translation).

In some embodiments, the selected dictionary may be enabled for use during just the second user input, and then disabled. In other embodiments, the selected dictionary may also be enabled for use in a third or more user input, and then disabled. In other embodiments, use of the selected dictionary is not disabled. In some embodiments, the selected dictionary is enabled for all or a subset of inputs made within the same dialogue and/or application as the first user input, and not enabled for other user inputs.

In some embodiments, one or more (or every) dictionary contains words from a different language and/or dialect. In some further embodiments, it is established the local language(s) or dialect(s) of the geographical locus is determined, and a corresponding language dictionary is selected. In some other embodiments the different dictionaries contain words that are related to different types of geographic locus—for example one dictionary contains terms that correspond to mountainous locations, with others containing terms that are associated with coastal locations, city locations, and so on. Dictionaries may be localised to a particular geographical area by the inclusion of town and/or street names in the dictionary, and/or other proper nouns.

Dictionaries may contain weighting information in order to prioritise the words they contain according to their frequency of use. Differently prioritised dictionaries may be associated with different geographical loci on the basis of their proximity to the word useage at or near those loci. For example, “Road” is an extremely common component of street names in Greater London (e.g. Gloucester Road), but does not occur anywhere within the City of London (the so-called “Square Mile”), where “Street” is instead very prevalent. Therefore, a dictionary that prioritises “Street” over “Road” may be selected based on a locus at least predominantly within the City of London, in preference to a lower-priority London dictionary that prioritises “Road” over “Street”. In the absence of the City of London dictionary, the lower-priority London dictionary could be selected in its place.

The selection and use of one dictionary does not necessarily preclude the simultaneous selection and use of one or more other dictionaries. Therefore, where two or more dictionaries are relevant to a geographical locus (e.g. French, Dutch and German dictionaries for the locus of Belgium) they may in some embodiments be selected and used together, either independently or by merging the contents of the dictionaries. Similarly, one or more dictionaries that have been selected based on a user-inputted indication of a geographic locus may be used in combination with dictionaries selected via other means—for example a dictionary that has been selected as a default option for the device. In other embodiments, only one dictionary is used at a time.

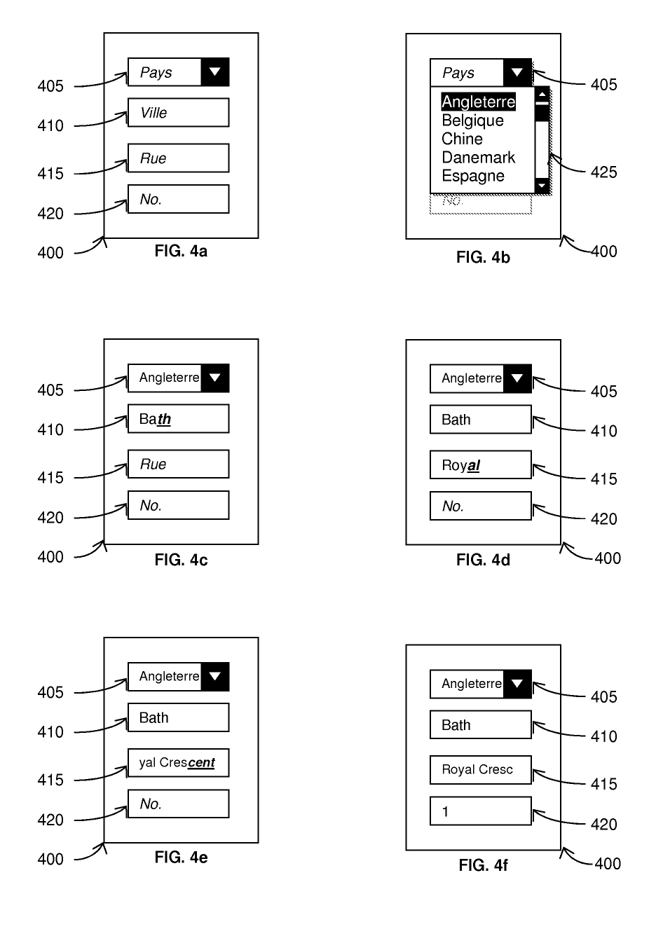

FIG. 4a shows an exemplary user interface dialogue 400 that may be presented to a user in an embodiment of the invention, for example on the screen 150 of MCD 100, or the screen 250 of MND 200. In this example the device belongs to a francophone user who is not familiar with English, but desires to enter into the dialogue the address for a property in England, perhaps in order to add an entry to his device's phonebook. The dialogue 400 is presented in the user's default language (French, in this case) and comprises a number of user interface components that, together, define an address comprising a country (“pays”), town (“ville”), road (“rue”), and house number (“No.”). The country component is a drop-down selection box 405, and the town, road, and number components are all textboxes (410, 415, and 420, respectively). Other input components and combinations of components could be used in the dialogue, for example radio buttons, slidebars, or other suitable components.

FIG. 4b illustrates the dialogue 400 of FIG. 4a, after the user has expanded the country selection box 405 to show a list 425 of selectable country options. Shown in the list of selection options are the countries England (“Angleterre”), Belgium (“Belgique”), China “(Chine”), Denmark (“Danemark”), and Spain (“Espagne”). Other countries are accessible by scrolling the list.

In FIG. 4c, the user has selected England “Angleterre” from the list 425 of country options. He has also begun to make an entry in the town textbox 410, by entering the characters “Ba”. The user is intending to enter the town name “Bath”.

The user's selection of “England” in the Country selection box 405 corresponds to the geographical locus of “England”. The device has been pre-configured to associate a selection of “England” with an English-language dictionary that is (in this example) already present on the device. The English language dictionary contains the word “Bath”, and this is offered to the user as an autocompletion candidate for his entry of “Ba”. In this particular example, the remaining letters “th” are highlighted in the town textbox 410 using underlining and bold, and the user can confirm acceptance of the candidate by pressing a particular button on his keypad.

In this example, the selected English-language dictionary remains enabled for use during the remaining text input operations within the dialogue 400. FIGS. 4d and 4e show a similar use of the autocomplete feature during entry of each of the two words in the road name “Royal Crescent”. Finally, in FIG. 4f the house number “1” is entered in the house number textbox 320. The English-language dictionary might still be during entry of the house number, in case the address uses a house name rather than a number.

Once all fields in the dialogue 400 have been completed, the selected English-language dictionary is disabled and the dialogue closes.

FIGS. 4a-f represents an exemplary example of an embodiment of the invention in use and it is clear that in practice the invention may use a dialogue and dictionaries that are different to those used in the example of FIGS. 4a-f.

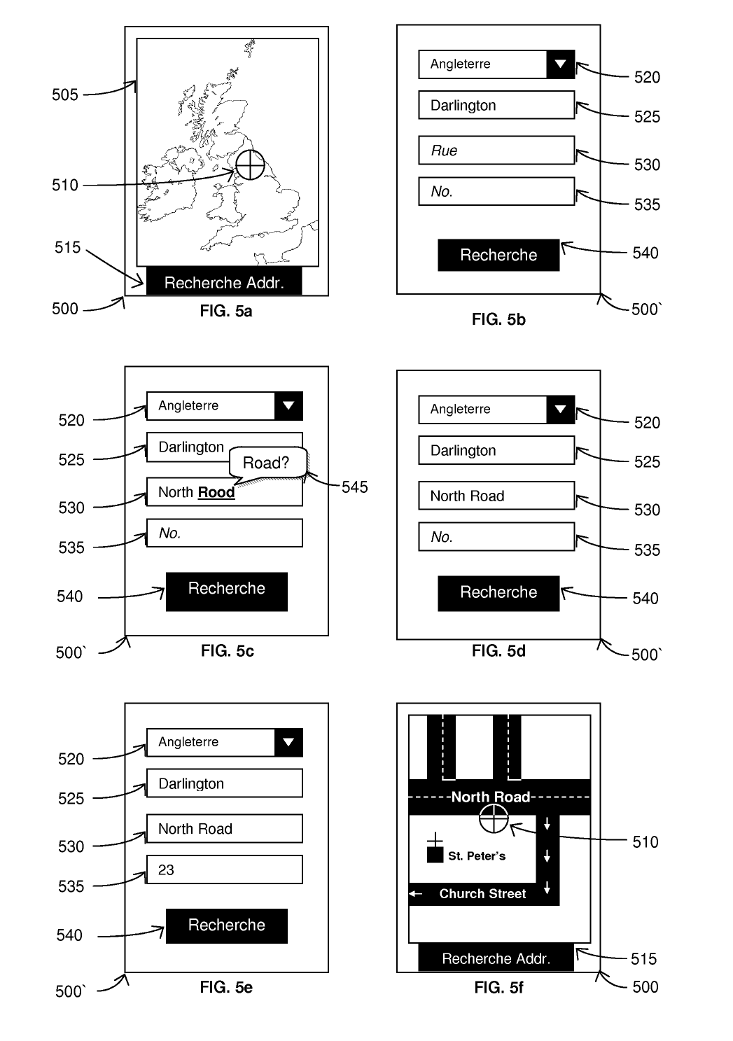

FIG. 5a shows an exemplary user interface window 500 that may be presented to a user in an embodiment of the invention, for example on the screen 150 of MCD 100, or the screen 250 of MND 200. Once again, the device is in use by a francophone user, who has set the default interface language to French. In this example the window includes a map area 505 which has been focused by the user on a location in the United Kingdom (in fact, upon a town called Darlington), represented by a reticule 510. The focusing may have been achieved by the user scrolling the map until the reticule was in its centre, selecting a point on the map to which the reticule was moved, by searching for an address, or via another user input technique. Also displayed is a button 515 labelled “Recherche Addr.” (“Search Addr.”, in French) which can be operated by the user to search for a particular street address.

FIG. 5b shows a dialogue 500′ that has been opened in response to the user operation of button 515. The dialogue includes a number of user input components for entering a street address: a drop-down box 520 for selecting a country, and text boxes for entering a town, road and house number (525, 530, and 535, respectively). The country 525 has been pre-selected to Angleterre (“England”, in French”) and the town to Darlington, based on the location of the map focus (i.e. the reticule 510). These two inputs may be changable by the user.

The map has been focused, by the user, at a single point in the UK, a location within the town of Darlington. In this particular example, the map coordinates of this point on the map are supplied to a function that matches map coordinates to official language, and returns English as the official language at that point. In this example, the device does not have a locally-stored English language dictionary, so instead connects to a remote dictionary server using a communications network, which grants the device remote access to an English language dictionary stored on the server. Alternatively, the device could download the selected dictionary or a portion of it from the server.

FIG. 5c illustrates the dialogue 500′ after the francophone user has attempted to enter the street name “North Road” into textbox 530. Unfortunately, the user's unfamiliarity with English (perhaps coupled with his use of a physically small text-input interface) has led him to make a typographical error, and what he has actually entered is “North Rood”. As the user is making this input, the device uses the remote dictionary to check the spelling of each word as it is entered. The string “Rood” is not contained within the selected dictionary, and has therefore been highlighted (in this example, using bold text) as potentially incorrect. In addition, the dictionary has been used to generate the most likely match “Road”, which is presented to the user as a correction candidate 545. The user can opt to accept the correction candidate, or ignore it and retain “Rood”.

In FIG. 5d the user has opted to accept the correction “Road” and the road text box contains the string “North Road”.

In FIG. 5e the user has entered the number “23” in the house number textbox 535. Finally, he presses the button 540 labelled “Recherche” (“Search”, in French), causing the device to search the map for the address details that he has entered.

In FIG. 5f the map has been redisplayed and focussed on the address entered in dialogue 500′ by the user.

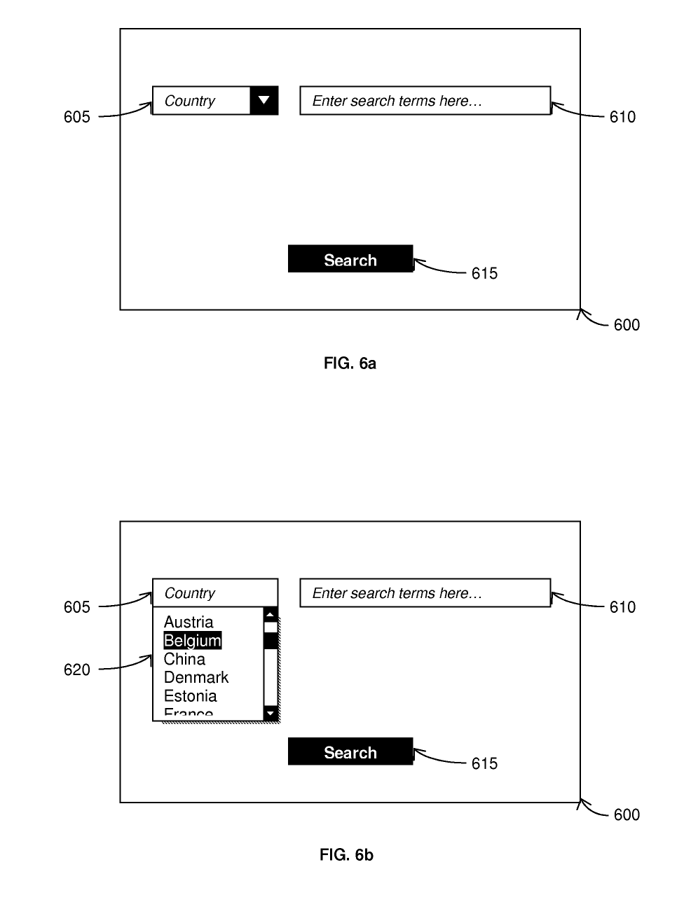

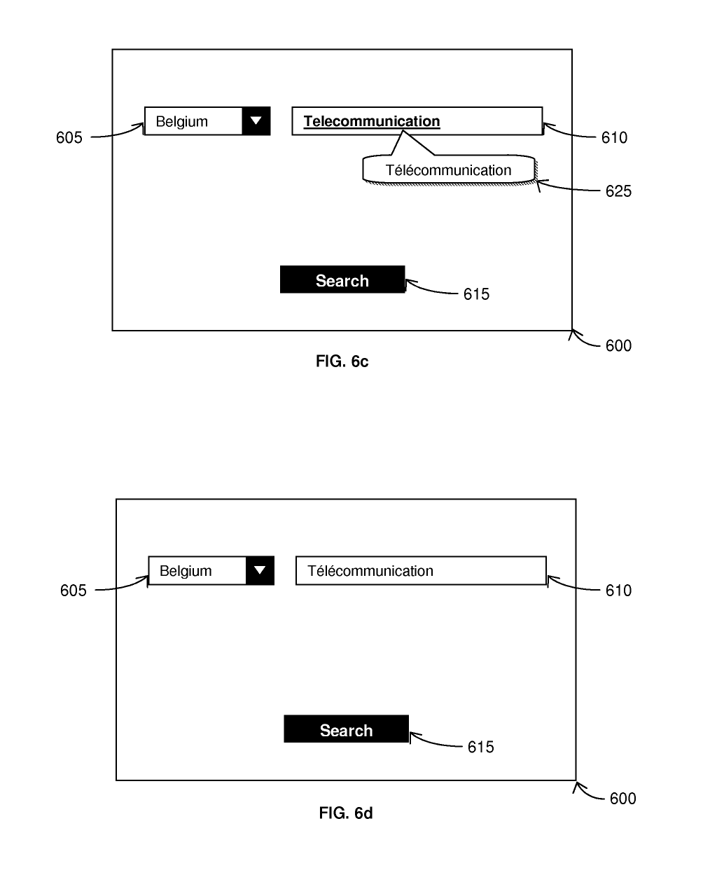

FIG. 6 illustrates a search interface 600 comprising a country selection drop-down box 605, a text box 610 for the entry of search terms, and a button that when pressed initiates a search of entries relating to a country selected via the drop-down box 605 that match search terms entered in the textbox 610. In this example, the search interface can access translation dictionaries for translating text from the user's default interface language (English) into other languages.

In FIG. 6b the user has selected “Belgium” from an expanded list 625 of countries accessible from the drop-down box 605. The interface then attempts to match the geographical area of Belgium to a dictionary based on its official language, however Belgium has three official languages, French Dutch and German and in this example a translation dictionary is accessible for each one. However, in this example the user has previously defined the French dictionary to have a higher priority than Dutch or German dictionaries, and the French dictionary is therefore selected in preference to the Dutch or German dictionaries.

In FIG. 6c the user has entered the English-language string “Telecommunication” into the search term textbox 610. In response, the interface uses the French translation dictionary to translate the entered text into French. In this example, the proposed French translation candidate 625 “Télécommunication” is in fact very similar to the English string, but contains French characters (“é”) that may not have been easily accessible or familiar to the user of an English-language interface.

In FIG. 6d the user has accepted the translation candidate 625 and the French text “Télé” has replaced the English text “Telecommunication” in the search term textbox 610. The user then selects the “Search” button 615 to initiate the search for data relating to France that contains the word ““Télé”.

In this example selection of the Country using the drop-down box 605 is not equivalent to specifying a language. Instead, it represents the selection of a geographic locus (the locus to which the search will correspond), based upon which a dictionary may be selected (based on official language, or other criteria, as discussed above).

Without in any way limiting the scope, interpretation, or application of the claims appearing below, a technical effect of one or more of the example embodiments disclosed herein is that a dictionary can be automatically selected, based on related user input fields, without requiring the user to change the default dictionary for his device. Another technical effect of one or more of the example embodiments disclosed herein is that errors in user input can be reduced, particularly when users are entering text in unfamiliar languages or dialects. Another technical effect of one or more of the example embodiments disclosed herein is that appropriate dictionaries can be used during user input without the user needing to know or determine the most appropriate language or dictionary for the input.

Embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIGS. 1 and 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus comprising:
a processor; and
memory including computer program code,
the memory and the computer program code configured to, working with the processor, cause the apparatus to perform at least the following:
receive a first user input indicative of a geographical locus;
select a first dictionary from a plurality of available dictionaries, based upon said geographical locus; and
enable use of the first dictionary during a second user input.

2. The apparatus of claim 1, wherein use of the second dictionary is enabled for only the second user input.

3. The apparatus of claim 1, wherein the first and second inputs are made within a single application.

4. The apparatus of claim 3, wherein the application is a navigation application.

5. The apparatus of claim 3, wherein the application is a search application.

6. The apparatus of claim 1, wherein the memory and the computer program code are further configured to, working with the processor, cause the apparatus to cause a map to be displayed, wherein receiving the first input comprises receiving user-selection of a locus on said displayed map.

7. The apparatus of claim 1, wherein the geographical locus is a single point.

8. The apparatus of claim 1, wherein the geographical locus is an area.

9. The apparatus of claim 8, wherein the area is a country.

10. The apparatus of claim 1, wherein each of the plurality of available dictionaries relates to a different language, and further wherein the first dictionary is selected based on a correspondance between the selected geographical locus and the language to which the first dictionary relates.

11. The apparatus of claim 1, wherein each of the plurality of available dictionaries relate to a different subset of words in the same language, and further wherein the first dictionary is selected based on a predetermined correspondance between the selected geographical locus and the subset of words to which the first dictionary relates.

12. The apparatus of claim 1, wherein the second input is an ambiguous input and enabling use of the first dictionary during a second user input comprises enabling the use of the first dictionary for generating at least one candidate word during said second user input.

13. The apparatus of claim 1, wherein enabling use of the first dictionary during a second user input comprises enabling the use of the first dictionary for generating at least one autocompletion candidate during said second user input.

14. The apparatus of claim 1, wherein enabling use of the first dictionary during a second user input comprises enabling the use of the first dictionary for performing a spellchecking function during said second user input.

14. The apparatus of claim 1, wherein enabling use of the first dictionary during a second user input comprises enabling the use of the first dictionary for performing a translation function during said second user input.

15. The apparatus of claim 1, being a mobile communication device.

16. The apparatus of claim 1, being a mobile navigation device.

17. A method comprising:
receiving a first user input indicative of a geographical locus;
selecting a first dictionary from a plurality of available dictionaries, based upon said geographical locus; and
enabling use of the first dictionary during a second user input.

18. The method of claim 17, wherein use of the second dictionary is enabled for only the second user input.

19. The method of claim 17, wherein the first and second inputs are made within a single application.

20. The method of claim 19, wherein the application is a navigation application.

21. The method of claim 19, wherein the application is a search application.

22. The method of claim 17, further comprising:
causing a map to be displayed,
wherein receiving the first input comprises receiving user-selection of a locus on said displayed map.

23. The method of claim 17, wherein the geographical locus is a single point.

24. The method of claim 17, wherein the geographical locus is an area.

25. The method of claim 24, wherein the area is a country.

26. The method of claim 17, wherein each of the plurality of available dictionaries relates to a different language, and further wherein the first dictionary is selected based on a correspondance between the selected geographical locus and the language to which the first dictionary relates.

27. The method of claim 17, wherein each of the plurality of available dictionaries relate to a different subset of words in the same language, and further wherein the first dictionary is selected based on a predetermined correspondance between the selected geographical licus and the subset of words to which the first dictionary relates.

28. The method of claim 17, wherein the second input is an ambiguous input and enabling use of the first dictionary during a second user input comprises enabling the use of the first dictionary for generating at least one candidate word during said second user input.

29. The method of claim 17, wherein enabling use of the first dictionary during a second user input comprises enabling the use of the first dictionary for generating at least one autocompletion candidate during said second user input.

30. The method of claim 17, wherein enabling use of the first dictionary during a second user input comprises enabling the use of the first dictionary for performing a spellchecking function during said second user input.

31. The method of claim 17, wherein enabling use of the first dictionary during a second user input comprises enabling the use of the first dictionary for performing a translation function during said second user input.

32. A computer program product comprising a computer-readable medium bearing computer program code embodied therein for use with a computer, the computer program code comprising:
receiving a first user input indicative of a geographical locus;
selecting a first dictionary from a plurality of available dictionaries, based upon said geographical locus; and
enabling use of the first dictionary during a second user input.

33. A computer-readable medium encoded with instructions that, when executed by a computer, perform:
receiving a first user input indicative of a geographical locus;
selecting a first dictionary from a plurality of available dictionaries, based upon said geographical locus; and
enabling use of the first dictionary during a second user input.
